(19) United States
(12) Patent Application Publication
(10) Pub. No.: US 2026/0197029 A1
(43) Pub. Date: Jul. 9, 2026

(54) USE OF A VEHICLE UWB SYSTEM

(71) Applicant: Valeo Comfort and Driving Assistance, Créteil (FR)

(72) Inventors: Onur Oguz, Créteil (FR); Riadh Berhouma, Créteil (FR)

(73) Assignee: Valeo Comfort and Driving Assistance, Créteil (FR)

(21) Appl. No.: 19/128,378

(22) PCT Filed: Nov. 7, 2023
(86) PCT No.: PCT/EP2023/080924

§ 371 Date: May 8, 2025

(30) Foreign Application Priority Data
Nov. 8, 2022 (FR) 2211587

(51) Int. Cl. H04B 1/7163; H04W 60/04; H04W 64/00; H04W 72/566

(52) U.S. Cl. CPC H04B 1/7163; H04W 60/04; H04W 64/00; H04W 72/566

(57) ABSTRACT

A method for using a vehicle ultra wide band (UWB) system that includes one or more UWB sensors and having registered a set of UWB devices. The set of UWB devices includes a first UWB device and a second UWB device. For each UWB device, the method includes a periodic reception of a programming of localizations by the one or more UWB sensors, including a first localization and a second localization. The method includes checking the reliability of execution of the programming of the first localization and the second localization. If the check fails, the method includes modifying the programming.

### TECHNICAL FIELD

The present disclosure relates to the use of a vehicle UWB (Ultra Wide Band) system.

### TECHNICAL BACKGROUND

Vehicles currently exist that are equipped with a UWB system comprising one or more UWB sensors that are installed in the vehicle. Such a UWB system normally registers a set of UWB devices and is then able to determine the position of each of the UWB devices from localizations between each of the UWB devices and the UWB sensors of the system. For this purpose, existing methods for using such UWB systems generally comprise a periodic reception of a programming of localizations for each UWB device, these localizations then being used to determine the position of each UWB device.

Each localization is usually programmed over a time interval and, during that time interval, the programmed localization comprises UWB transmissions between one of the UWB devices and each of the UWB sensors. When two localizations are programmed such that they would overlap if they were executed, i.e. when the time intervals over which they are programmed have a non-zero intersection, existing methods generally comprise cancelling the programming of one of the two localizations. This reduces the risk of interference between the UWB transmissions of the two localizations. However, such a cancellation reduces the number of localizations finally executed for the UWB device for which one of the localizations was cancelled. As a result, the accuracy and sensitivity of the localization are reduced for that UWB device.

For this reason, there is a need for an improved vehicle UWB system.

### SUMMARY

To this end, a method is proposed for using a vehicle UWB system comprising one or more UWB sensors and having registered a set of UWB devices. The set of UWB devices comprises a first UWB device and a second UWB device. For each UWB device, the method comprises a period reception of a programming of localizations by the one or more UWB sensors, including a first localization and a second localization. The first localization is a localization of the first UWB device programmed over a first time interval. The second localization is a localization of the second UWB device programmed over a second time interval. The first time interval and the second time interval have a non-zero intersection for at least one period. For each of the at least one period, the method comprises periodically checking the reliability of execution of the programming of the first localization and the second localization, and, if the check fails, modifying the programming.

Each localization can comprise UWB transmission exchanges. The check can comprise determining the temporal distances between the UWB transmissions of the first localization and the UWB transmissions of the second localization, and checking that each of the determined temporal distances is at least greater than a predetermined temporal distance value.

Modifying the programming if the check fails can comprise determining a priority UWB device from the first UWB device and the second UWB device, and programming the localization of the priority UWB device.

The predetermined temporal distance value can be greater than 250 microseconds and/or less than 1 millisecond.

The programming of the localizations can be carried out for a duration of less than 10 seconds.

The method can comprise detecting a new UWB device, and repeating the reception of the programming and the check for the new UWB device.

Following the check, the method can comprise executing the localizations according to the received programming if the check is successful or according to the modified programming if the check fails, and determining the position of each UWB device from the executed localizations.

A vehicle UWB system is also proposed. The UWB system comprises one or more UWB sensors. The system is configured to be used according to the method.

A UWB sensor for such a vehicle UWB system is also proposed. The UWB sensor is configured for a use of the system according to the method.

A computer program is also proposed. The computer program comprises program code instructions for carrying out the method when said program is executed by a processor.

### BRIEF DESCRIPTION OF THE FIGURES

Non-limiting examples will be described with reference to the following figures:

FIG. 1 shows a flowchart of an example of the method.

FIG. 2 shows an example of the programming of a plurality of localizations.

FIG. 3 shows an example of a localization implemented within a time interval consisting of a series of time slots.

FIG. 4 shows a first example of an implementation of the method.

FIG. 5 and FIG. 6 show a second example of an implementation of the method.

FIG. 7 shows an example of a use of the vehicle based on the localizations programmed according to the method.

FIG. 8 shows an example of the localization of a UWB device with the one or more UWB sensors.

FIG. 9 shows an example of the determination of the number of time slots of each series for a UWB device.

FIG. 10 shows an example of a vehicle UWB system.

### DETAILED DESCRIPTION

A method is proposed for using a vehicle UWB system comprising one or more UWB sensors and having registered a set of UWB devices. The set of UWB devices comprises a first UWB device and a second UWB device. For each UWB device, the method comprises a period reception of a programming of localizations by the one or more UWB sensors, including a first localization and a second localization. The first localization is a localization of the first UWB device, and the first localization is programmed over a first time interval. The second localization is a localization of the second UWB device, and the second localization is programmed over a second time interval. For at least one period, the first time interval and the second time interval have a non-zero intersection. For each of the at least one period (i.e. for each period during which the time interval of the first localization has a non-zero intersection with the time interval of the second localization), the method comprises checking the reliability of execution of the programming of the first localization and the second localization, and, if the check fails, modifying the programming.

The method offers improved use of the vehicle UWB system.

Checking the reliability of execution actually enables a prior assessment of whether the first localization and the second localization can be executed correctly according to their programming, and the method comprises modifying the programming if this check fails (i.e. if the method anticipates unreliable execution as a result of the check). This check is particularly relevant since the first localization and the second localization are programmed over time intervals having a non-zero intersection over at least one period. The method thus enables a response to the detection of a future lack of reliability, thereby reducing the risk of interference between the first localization and the second localization for each period during which these two localizations would otherwise overlap during their execution.

The check further avoids the direct but suboptimal solution consisting in systematically cancelling the programming of one or two of the first or second localizations if their time intervals have a non-zero intersection. The method in fact potentially retains the programming of these two localizations when they allow it, and modifies the programming only if the check fails. In particular, cancelling a localization reduces the number of localizations programmed for the UWB device involved in the cancelled localization, thereby reducing the accuracy and sensitivity of the localization. The method thus enables an overall increase over time in the accuracy and sensitivity of the localization of UWB devices.

Following the check, the method can comprise an execution of the localizations. If the check is successful, the method can comprise executing the localizations according to the originally received programming. If the check fails, the method can comprise executing the localizations according to the modified programming. The method can comprise, for example, executing the localizations except for the localization that was cancelled.

Following the execution of the localizations, the method can comprise determining the position of each of the UWB devices on the basis of the executed localizations. Each localization of a UWB device can comprise, for example, providing the position of the UWB device relative to the UWB system. For each UWB sensor, the localization can comprise, for example, measuring the respective distance between the UWB device and the UWB sensor, and determining the position of the UWB device relative to the UWB system on the basis of the measurements of the respective distance between the UWB device and each of the UWB sensors. The determined position can vary over time. Each localization can provide, for example, a position of a UWB device relative to the UWB system at a given time, and all of the executed localizations involving that UWB device can provide a change over time in the position of that UWB device.

Following the execution of the localizations, the method can comprise using the relative positions of the determined UWB devices one or more times. The method can comprise, for example, activating one or more functionalities of the vehicle depending on the relative positions of the first and second UWB devices. The functionality can comprise, for example, locking the vehicle when it is determined that the first and second UWB devices are located outside the vehicle, for example after a predetermined time period has elapsed between the time when it is determined that each of the first and second UWB devices is outside. In examples, the functionality can comprise selectively unlocking one or more of opening elements of the vehicle (for example, a driver's door, a passenger door or a vehicle trunk) depending on the relative positions of the determined UWB devices. The functionality can comprise, for example, unlocking the driver's door and the vehicle trunk when the position of one of the UWB devices approaches the driver's door (for example, the first UWB device) and when the position of another of the UWB devices (for example, the second UWB device) approaches the trunk (i.e. when two users carrying these devices approach these opening elements, for example at the same time or one after the other). In other examples, the functionality can comprise unlocking the driver's door and/or passenger doors (for example, when one or more users approaches these opening elements), and making one or more adjustments for each user (for example, adjustment of head restraint height or seat position) according to a user access zone (for example, depending on the opening element which the user has approached). In yet further examples, the functionality can comprise activating one or more vehicle functions such as switching on music or adjusting rear-view mirrors to suit the person carrying the UWB device which is positioned on the driver's seat (the first UWB device when the person carrying the first UWB device is the driver, and the second UWB device when the person carrying the second UWB device is the driver). The method can comprise any combination of these examples of functionality.

For each UWB device, the method comprises receiving a programming of localizations by the one or more UWB sensors. The programming can comprise programming one or more respective localizations for each UWB device. The received programming can be a numerical datum. For each UWB device, and for each localization involving the UWB device, the programming can comprise digital data defining a time-based positioning of the localization, for example on a timeline. The time line can represent a time period to come that has not yet elapsed at the time when the programming is received. The numerical data defining the localization can comprise a datum designating a start time of the time interval for which the localization is programmed and a datum designating an end time of that time interval. Additionally or alternatively, the numerical data defining each localization can comprise numerical data defining each of the UWB transmissions of the localization. For example, the digital data can designate a start time and an end time for each UWB transmission of the localization.

The received programming can have been calculated for each period, for example by the UWB system. For example, before each period, the method can comprise calculating a programming for each localization and recording the programming, for example, in a memory of the system. For example, for each UWB device in the set, the number of localizations programmed per period can depend on the UWB device. For example, before the programming is first received, the method can comprise an exchange with the UWB device in order to determine the number of localizations to be programmed per period. The exchange can comprise sending frequency information for the UWB device from the UWB device to the UWB system, and calculating, by the UWB system, of the number of localizations to be programmed per period based on the frequency information. The frequency information can be a frequency or a duration that is specific to the UWB device. After this calculation, receiving the programming can comprise reading the programming, from the system memory.

In the received programming, one or more respective localizations of the same UWB device can be programmed such that they are separated in time. This means that, at each given time, only one localization of the same UWB device is programmed to be executed. For example, one or more respective localizations of the same UWB device can be programmed to be executed successively, one after the other. Each localization can be programmed to be executed over a respective time interval, i.e. the UWB transmissions of the localization can be performed within the respective time interval. Each UWB transmission of the localization can start at the same time or after a start time of the respective time interval, and can end before or at the same time as an end time of the respective time interval. The UWB transmissions of the same localization can be separated in time over the respective time interval. The respective time intervals of one or more respective localizations of the same UWB device can occur at different times. Two successive time intervals can follow one another directly (i.e. the end of one localization can correspond to the start of the following localization), or they can be separated by a given time period.

The respective time intervals of the respective localizations of the first UWB device and the second UWB device do not all occur at different times. The first localization of the first UWB device is programmed over a first time interval that overlaps the second time interval of the second localization of the second UWB device. The first time interval and the second time interval have a non-zero intersection. For example, each of the first and second time intervals can comprise a respective start time and a respective end time, and the respective start time of the first time interval can occur before the respective start time of the second time interval, and the respective end time of the first time interval can occur after the respective start time of the second time interval.

Alternatively, the respective start time of the first time interval can occur after the respective start time of the second time interval, and the respective end time of the second time interval can occur after the respective start time of the first time interval. As a further alternative, the respective start times of the first and second time intervals can be combined and/or the respective end times of the first and second time intervals can be combined.

“Periodic/periodically” means that, for a given time duration, the method comprises receiving a programming of localizations for each UWB device and, when the time intervals of two localizations of the received programming have a non-zero intersection, checking the programming, and, at regular intervals of this given time duration, the method repeats the reception of the programming for each UWB device and, in the case of a non-zero intersection, the check on the programming. The period represents the duration of this given time interval during which the programming for each UWB device is received and, in the case of a non-zero intersection, the programming is checked.

For each of the at least one period, the method comprises checking the reliability of execution of the programming of the first localization and the second localization. For the other periods, the method may not carry out the execution reliability check. For example, at the beginning of each period (or before a group of periods and for each period in the group), the method can comprise testing for non-intersection of the time intervals of the programmed localizations in order to determine whether the intersection of the time intervals of at least two localizations is non-zero. If this test fails, i.e. if at least two localizations are programmed over time intervals having a non-zero intersection, the method can comprise checking the reliability of execution of the programming of these at least two localizations. If this test is successful, the method may not perform the execution reliability check, and may directly wait for or move on to the next period. Alternatively, the method can carry out the check at each period, in which case the method may not comprise the test.

The term “UWB device” (or “identifier”) refers to a mobile object identifiable by the vehicle, the localization of which, for example, allows or does not allow one or more (specific) actions of the vehicle. The UWB device can be used, for example, to open the vehicle and/or start the engine of the vehicle. The method can comprise, for example, opening the vehicle when the UWB device is located near the vehicle, or starting the engine when the UWB device is inside the vehicle. The method can involve one or more keys and/or smart devices, such as a mobile phone, as a UWB device or as UWB devices.

The programming of localizations can be carried out for a duration, for example, equal to one period, or to several times the period. The programming can comprise determining, for each localization, a respective time interval for this duration in which the localization is performed. The programming of the localizations can be carried out for a duration of less than 10 seconds. The programming of the localizations can be carried out for a duration greater than 1 second.

The duration in which the programming is carried out can be a time that has not yet elapsed, i.e. a time to come in relation to the time of the programming and the execution of the method. The length of the duration can be set or can also vary, for example depending on the environment of the vehicle.

Each UWB transmission can comprise the sending of a frame by the UWB device to one or more UWB sensors or the sending of a frame by one or more UWB sensors to the UWB device. UWB may refer to a communication protocol, for example, the communication protocol specified by IEEE 802.15.4. For each localization, the programming of the one or more localizations can comprise determining a temporal position for each of the frame transmissions. A frame transmission can take between 60 and 137 microseconds. The determination of a temporal position for a frame transmission can comprise determining a frame transmission start time and a frame transmission end time. The time between the start and the end can be equal to a transmission duration. The transmission duration can depend on the length of the frame and the transmission rate. The positioning of the start and end can depend on the length of the frame and/or the transmission rate.

For each localization, the respective time interval over which the localization is programmed can be made up of a series of time slots. The time slots of the series can be of more or less equal duration. Each slot can, for example, have a duration greater than or equal to 1 millisecond and/or less than or equal to 8 milliseconds. The duration of the slot can depend on the UWB device involved in the localization.

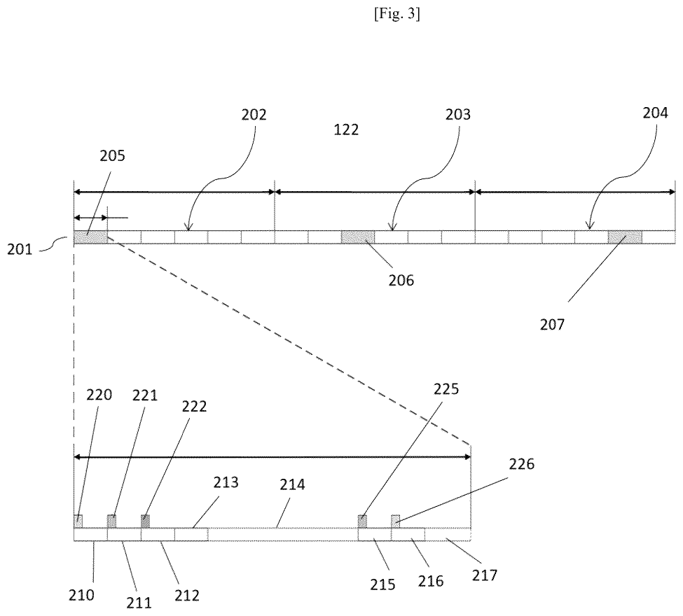

For each UWB device, the programming can comprise programming the localizations over a respective session corresponding to one period. A session can have a duration that corresponds to a multiple of a predetermined time, for example once, twice, three times, or ten times 96 milliseconds. References in parentheses are indicated below with reference to FIG. 3. Each session (201) can be divided into blocks (202, 203, 204). Each block can be divided into a plurality of time intervals (205, 206, 207), and a localization can be carried out within one of these time intervals. Each of the time intervals can be divided into a series of time slots (210, 211, 212, 215, 216). The UWB transmissions of each localization can be carried out within time slots of a series of the UWB device session. For each session, the blocks, the time intervals of each block, and the time slots can be numbered and, for each localization of the session during the period, the received programming can comprise numerical data defining, for each block, the number of the time interval over which the localization is programmed. For each localization of the session during the period, the received programming can also comprise the number of the time slot of the time interval over which each UWB transmission of the localization is programmed. The calculation of the programming of each UWB device can comprise determining the number of time slots in each series, the number of time slots in each block, and/or the number of blocks per session for each UWB device.

“Checking the reliability of execution of the programming of the first localization and the second localization” means evaluating a reliability criterion for the results that would be obtained by the first localization and the second localization if they were executed according to a given programming, in this case the programming that is initially received in the method. The reliability criterion can correspond, in particular, to the potential presence of interference between the UWB transmissions linked to the first localization and the UWB transmissions linked to the second localization. The check “fails” if the UWB transmissions are such that interference is expected, and, conversely, the check “is successful” if interference is not expected, at least not between the first localization and the second localization precisely.

The execution reliability check allows a prior evaluation of whether the first localization and the second localization can be executed correctly according to their programming. The check in fact “fails” if the UWB transmissions linked to the first localization and the second localization are such that interference is expected. In this case, the method anticipates unreliable execution following the check, and the method comprises modifying the programming. The method thus enables a response to the detection of a future lack of reliability, thereby reducing the risk of interference between the first localization and the second localization for each period during which these two localizations would otherwise overlap during their execution.

In particular, the check avoids the direct but suboptimal solution consisting in systematically cancelling the programming of one or two of the first or second localizations when their time intervals have a non-zero intersection. The method potentially retains the programming of these two localizations if interference is not expected, and modifies the programming only if interference is expected. Since cancellation reduces the accuracy and sensitivity of the localization, the method thus enables an overall increase over time in the accuracy and sensitivity of the localization of the UWB devices.

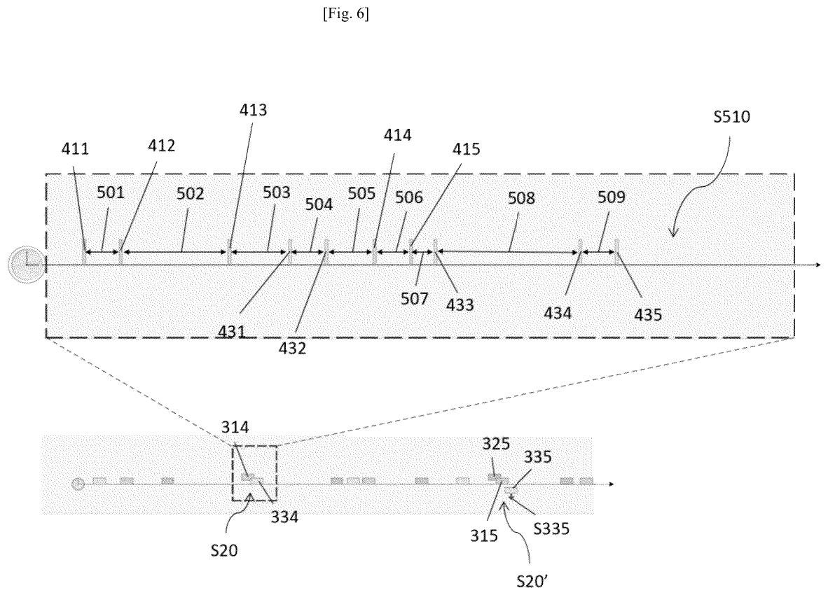

The execution reliability check can consist in checking that a temporal distance between the UWB transmissions of the first localization and the UWB transmissions of the second localization is at least greater than a predetermined temporal distance value. The check can thus comprise determining the temporal distances (503, 505, 507 in FIG. 6) between the UWB transmissions of the first localization and the UWB transmissions of the second localization (for example, with the exception of the temporal distances between two successive UWB transmissions of the same localization). For example, each UWB transmission can be provided over a respective time interval, and the time intervals of the UWB transmissions of the first localization and the second localization can follow one another. The temporal distance can be the temporal distance between the respective time intervals of the successive UWB transmissions. For each UWB transmission, the verification can then comprise determining the temporal distance with a preceding UWB transmission and a following UWB transmission. For each UWB transmission, the temporal distance can correspond to a time period that has elapsed between the end of the frame transmission of the preceding UWB transmission and the start of the frame transmission of the UWB transmission, or a time period that has elapsed between end of the frame transmission of the UWB transmission and the start of the frame transmission of the following UWB transmission. When the temporal distance between each of the respective time intervals of the localizations is greater than the predetermined temporal distance value, the check can be successful, and conversely, when at least one temporal distance between two respective time intervals of two localizations is less than the predetermined temporal distance value, the check may fail. Alternatively, two time intervals of two UWB transmissions may not follow one another, i.e. the respective time interval of a first of the UWB transmissions can have a non-zero intersection with the respective time interval of a second of the UWB transmissions. In this case, the temporal distance between these two UWB transmissions can be zero, and the check may fail.

After determining the temporal distances, the check can comprise checking that each of the determined temporal distances (for example, with the exception of the temporal distances between UWB transmissions of the same localization) is at least greater than a predetermined temporal distance value. The check can comprise comparing each of the determined temporal distances with the predetermined temporal distance value. The predetermined temporal distance value can be greater than or equal to 250 microseconds, for example strictly greater than 250 microseconds. The predetermined temporal distance value can be less than or equal to 1 millisecond, for example strictly less than 1 millisecond.

If the execution reliability check is successful, the method can comprise executing the localizations according to the received, i.e. initial, programming. The method may not modify the programming of the first and second localizations. The method can retain the programming of the first and second localizations.

If the check fails, the method comprises modifying the programming. Modifying the programming can comprise cancelling a localization from the first and second localizations.

If the check fails, modifying the programming can comprise, for example, randomly cancelling a localization from the first and second localizations. Modifying the programming can comprise randomly selecting a localization from the first and second localizations, and cancelling the programming of the randomly selected localization. The method can then comprise executing the localizations according to the modified programming, i.e. executing the localizations except for the randomly selected localization.

Alternatively, if the check fails, the programming modification can be based on an order of priority between the UWB devices. Modifying the programming can comprise determining a priority UWB device from the first UWB device and the second UWB device, and programming the localization of the priority UWB device only. For example, the UWB devices in the set can be prioritised by the UWB system. Each UWB device can comprise a prioritization in relation to the other UWB device(s) in the set. Determining a priority UWB device can comprise comparing the prioritizations of the first UWB device and the second UWB device. The determination can comprise determining the UWB device from the first UWB device and the second UWB device which has the higher prioritization as the priority UWB device. Alternatively, one of the UWB devices in the set can be a priority UWB device, i.e. it can be designated as such in the UWB system. In this case, when the first UWB device or the second UWB device is the priority UWB device, the method determines it as such (the other UWB device being a secondary UWB device in relation to the priority UWB device).

The method can then comprise programming the localization of the UWB priority device only. The method can comprise cancelling the programming of the localization of the other UWB device, i.e. the UWB device from the first UWB device and the second UWB device which is not determined as the priority UWB device. The programming of the localizations of the priority UWB device is unchanged, and the programming of the UWB device that is not determined as the priority UWB device includes one fewer localization. The method can then comprise executing the programmed localizations, including an execution of all the localizations initially programmed for the priority UWB device, and the localizations initially programmed for the UWB device which is not determined as the priority UWB device, except for the localization of which the programming was cancelled.

In examples, the localizations can comprise a third localization which is a localization of a third UWB device programmed over a third time interval. The third time interval can have a non-zero intersection with the first time interval and/or the second time interval. In this case, the method can comprise checking the programming of the first localization, the second localization and the third localization (the temporal distances are then determined between each of the UWB transmissions of the first localization, the second localization and the third localization). If the check fails, the method can comprise determining a priority UWB device from the first UWB device, the second UWB device and the third UWB device, and programming the localization of the priority UWB device, i.e., cancelling the other localizations from the first localization, the second localization and the third localization that are not localizations of the priority UWB device. The method can similarly check the programming of a number N of overlapping localizations, and can program only the localization of the UWB device that is determined as the priority UWB device if this check fails.

The UWB system may have registered one or more UWB devices other than the UWB devices in the set that are involved in the method. The method can detect that the one or more other UWB devices are not within range of the vehicle, and can therefore decide not to involve them in the use of the method.

In examples, the method can comprise detecting a new UWB device. For example, the new UWB device can be a UWB device from the one or more other UWB devices that are registered in the UWB system. The new UWB device can, for example, be a UWB device that was not within range of the vehicle at the start of the execution of the method, and has just come within range of the vehicle (and is therefore detected by the UWB system). The method can comprise repeating the reception of the programming and the check for the new UWB device.

A UWB sensor for a vehicle UWB system is also proposed. The UWB sensor is configured for a use of the system according to the method of use and/or for carrying out the programming method.

The UWB sensor can be configured to perform both localization and radar measurements, and/or to be programmed for this purpose. The UWB sensor can be configured to receive one or more commands (for example received from the UWB system) to transmit a frame of a UWB exchange and/or transmit a frame of a radar measurement. The UWB sensor can be configured, after a transmission of a frame of a radar measurement, to change configuration before transmitting a frame of a UWB exchange or, after a transmission of a frame of a UWB exchange, to transmit a frame of a radar measurement. The UWB sensor can be configured to make this change, for example, in less than one millisecond.

A vehicle UWB system is also proposed. The UWB system comprises one or more UWB sensors. The system is configured to be used according to the method. The UWB system can be configured to send one or more commands to each UWB sensor after the method is carried out, based on the initial programming if the check is successful or based on the modified programming if the check fails. One or more commands can comprise requests to send frames of the UWB transmissions of the localizations according to the initial programming if the check is successful, or according to the modified programming if the check fails.

A UWB sensor for such a vehicle UWB system is also proposed. The UWB sensor is configured for a use of the system according to the method. The UWB sensor is configured to receive the one or more commands sent by the UWB system, and to execute the transmissions of the frames of the UWB transmissions of the localizations according to the transmitted commands, i.e. according to the initial programming if the check is successful, or according to the modified programming if the check fails.

A computer program is also proposed. The computer program comprises program code instructions for carrying out the method when said program is executed by a processor. The computer program can be stored in a memory. The UWB system can comprise the processor and/or the memory.

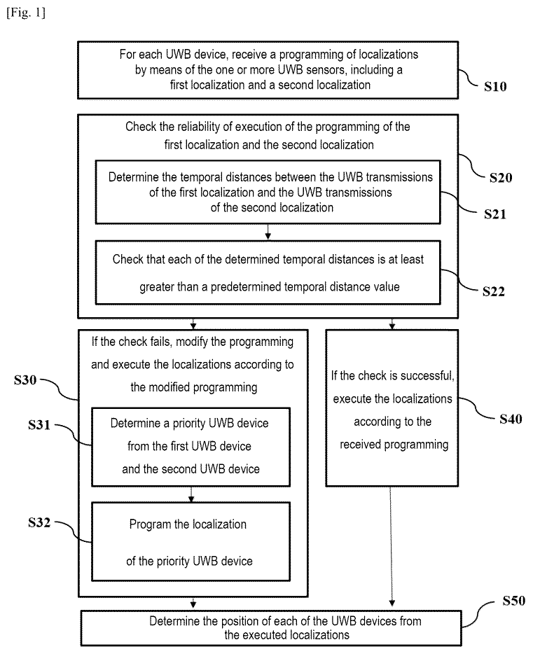

Examples will now be given with reference to FIGS. 1 to 10.

[FIG. 1] shows a flowchart of an example of the method. The method is a method for using a vehicle UWB system comprising one or more UWB sensors and having registered a set of UWB devices. The set of UWB devices comprises a first UWB device and a second UWB device. For each UWB device, the method comprises a periodic reception S10 of a programming of localizations by the one or more UWB sensors, including a first localization and a second localization. The first localization is a localization of the first UWB device, and the first localization is programmed over a first time interval. The second localization is a localization of the second UWB device, and the second localization is programmed over a second time interval. For at least one period, the first time interval and the second time interval have a non-zero intersection. For each of the at least one period, the method comprises checking S20 the reliability of execution of the programming of the first localization and the second localization, and, if the check fails, modifying S30 the programming.

The check S20 comprises determining S21 the temporal distances between the UWB transmissions of the first localization and the UWB transmissions of the second localization, and checking S22 that each of the determined temporal distances is at least greater than a predetermined temporal distance value. Modifying S30 the programming if the check fails comprises determining S31 a priority UWB device from the first UWB device and the second UWB device, and programming S32 the localization of the priority UWB device.

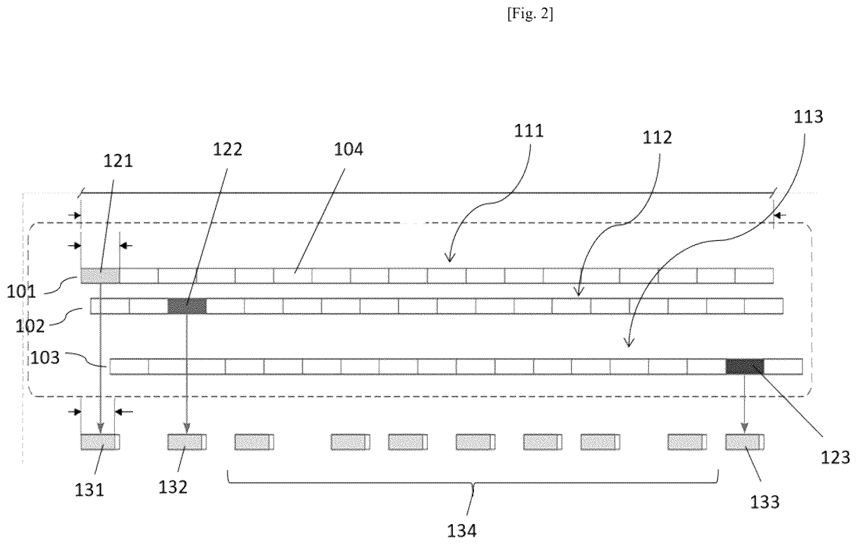

After the check S20, the method comprises executing the localizations according to the received programming if the check is successful S40, or according to the modified programming if the check fails S30, and determining S50 the position of each UWB device from the executed localizations.

[FIG. 2] shows an example of the programming of localizations. FIG. 2 shows, for each UWB device 101, 102, 103, a respective block 111, 112, 113. Each block can last, for example, 288 milliseconds. Each respective block 111, 112, 113 comprises eighteen time intervals 104. Each time interval can last, for example, 16 milliseconds. For each UWB device, the method of use includes a localization 121, 122, 123 of the UWB device with the one or more UWB sensors. The localization 121 involves the UWB device 101, the localization 122 involves the UWB device 102, and the localization 123 involves the UWB device 103. Each localization comprises an active RF part (RF being the acronym for Radio Frequency). The active RF part corresponds to the portion of the time interval over which the localization comprises UWB transmissions. In the figure, the active FT part 131 corresponds to the localization involving the UWB 101 device, the active FT part 132 corresponds to the localization involving the UWB 102 device and the active FT part 133 corresponds to the localization involving the UWB device 103. The figure also shows other active FT parts 134 corresponding to the localization involving other UWB devices (not shown).

[FIG. 3] shows an example of a localization implemented within a time interval consisting of a series of time slots. The figure shows a session 201 of a UWB device. The session can comprise, for example, three blocks 202, 203, 204, each comprising, for example, six time intervals. The method of use comprises a respective localization for each of the three blocks. For each block, the localization is implemented within one of the six time intervals of the block (time interval 205 for block 202, time interval 206 for block 203 and time interval 207 for block 204).

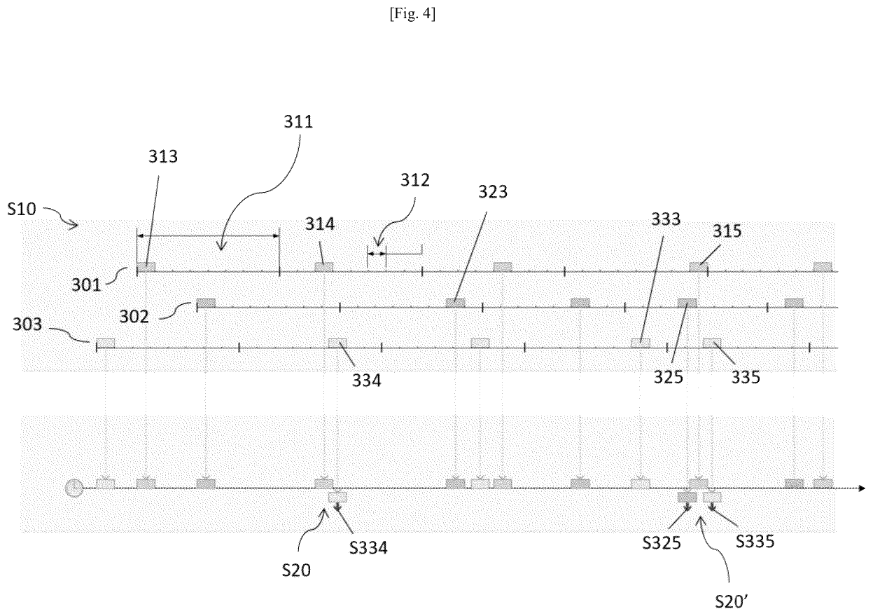

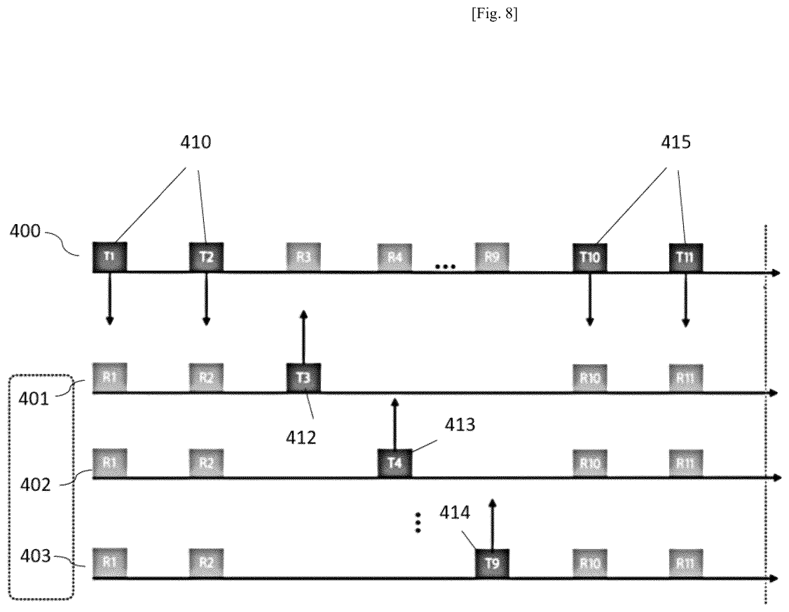

The localization implemented within the interval 205 (which is equivalent to 401 in FIG. 8) will now be discussed in more detail. The other localizations can be implemented in the same way. The time interval 205 consists of a series of time slots 210, 211, 212, 213, 214, 215, 216, 217. The UWB device involved in the localization can be a priority UWB device or a secondary UWB device. The localization implemented within the interval 205 comprises UWB transmissions between the UWB device and the one or more UWB sensors. Each UWB transmission comprises transmitting a frame between the UWB device and the one or more UWB sensors. The transmissions of frames of the UWB transmissions between the UWB device and the one or more UWB sensors are carried out within slots of the series (time slots 210, 211, 212, 214, 215 and 216). The transmission of frame 220 is carried out in slot 210, the transmission of frame 221 in slot 211 and the transmission of frame 222 in slot 212. Frames 220 and 221 are transmitted from the UWB device to each of the one or more UWB sensors. In time slots 212, 213 and 214, each of the one or more UWB sensors performs a respective transmission of a frame to the UWB device (for example frame 222 in slot 212). The transmission of frame 225 is then carried out in slot 215 and the transmission of frame 226 in slot 216. Frames 225 and 226 are transmitted from the UWB device to each of the one or more UWB sensors. Frames 220, 221, 222, 225, and 226 are transmitted at the beginning of time slots 210, 211, 212, 215, and 216.

[FIG. 4] shows a first example of an implementation of the method. The UWB system has registered a set comprising a first UWB device 301, a second UWB device 302, and a third UWB device 303. For each UWB sensor, the method comprises a periodic reception S10 of a programming of localizations by the one or more UWB sensors. For each UWB device, the received localization programming comprises a localization for each of the blocks of the period, and, for each localization, the time interval 312 of the block over which the localization is provided. For example, for the first block 311 of the session of the first UWB device 301, the programming comprises a numerical datum indicating that the localization is provided over the first time interval 313 of block 311.

The localizations of the programming received for this period comprise a first localization 314 and a second localization 334 which overlap. The first localization 314 is a localization of the first UWB device 301 programmed over a first time interval, and the second localization 334 is a localization of the third UWB device 303 programmed over a second time interval. The first time interval and the second time interval have a non-zero intersection.

The method includes checking S20 the reliability of execution of the programming of the first localization and the second localization. The check comprises determining the temporal distances between the UWB transmissions of the first localization and the UWB transmissions of the second localization, and checking that each of the determined temporal distances is at least greater than a predetermined temporal distance value. In this first example, the check fails. Each of the determined temporal distances is therefore not at least greater than the predetermined temporal distance value. For example, two UWB transmissions overlap, or are not separated by a temporal distance greater than or equal to the predetermined temporal distance value. The method then comprises modifying the programming. In this example, modifying the programming comprises cancelling S334 the second localization 334 initially programmed for the third UWB device 303 (the first UWB device 301 taking priority, for example, over the third UWB device 303).

The localizations of the programming received for this period comprise a third localization 315, a fourth localization 325 and a fifth localization 335 which overlap. The third localization 315 is a localization of the first UWB device 301 programmed over a third time interval, the fourth localization 325 is a localization of the second UWB device 302 programmed over a fourth time interval, and the fifth localization 335 is a localization of the third UWB device 303 programmed over a fifth time interval. The third time interval has a non-zero intersection with the fourth time interval and with the fifth time interval.

The method therefore comprises checking S20′ the reliability of execution of the programming of the third localization 315, the fourth localization 325 and the fifth localization 335. The check comprises determining the temporal distances between the UWB transmissions of the third localization 315, the fourth localization 325 and the fifth localization 335, and checking that each of the determined temporal distances is at least greater than a predetermined temporal distance value. In this first example, the check fails, so each of the determined temporal distances is not at least greater than the predetermined temporal distance value. For example, the temporal distances between the UWB transmissions of the third localization 315 and the fourth localization 325, and the temporal distances between the UWB transmissions of the third localization 315 and the fifth localization 335 are not all greater than the predetermined temporal distance value.

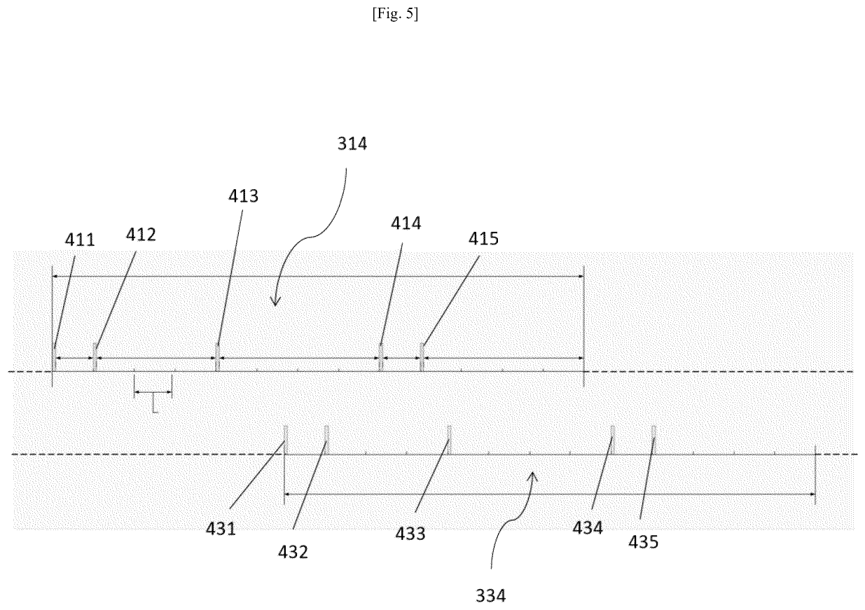

The method then comprises modifying the programming. In this example, modifying the programming comprises cancelling S325 the fourth localization 325 initially programmed for the second UWB device 302 and cancelling S335 the fifth localization 335 initially programmed for the third UWB device 303 (for example, the first UWB device 3014 takes priority over the second UWB device 302 and the third UWB device 303).

[FIG. 5] and [FIG. 6] show a second example of an implementation of the method. In this example, the check S20 on the reliability of execution of the programming of the first localization and the second localization is successful. FIG. 5 shows the UWB transmissions 411, 412, 413, 414 and 415 of the first localization 314 and the UWB transmissions 431, 432, 433, 434 and 435 of the second localization 334. FIG. 6 shows the temporal distances 501, 502, 503, 504, 505, 506, 507, 508, 509 between the UWB transmissions 411, 412, 413, 414 and 415 of the first localization 314 and the UWB transmissions 431, 432, 433, 434 et 435 of the second localization 334. The determination comprises projecting S510, on the same time line, the UWB transmissions 411, 412, 413, 414 of the first localization 314 and the UWB transmissions 431, 432, 433, 434 and 435 of the second localization 334, and, by following the time line, determining the temporal distances 501, 502, 503, 504, 505, 506, 507, 508, 509 between each of the projected successive transmissions. The check comprises determining the temporal distances between the UWB transmissions of the first localization and the UWB transmissions of the second localization (i.e. except for the temporal distances between two UWB transmissions of the same localization). For example, the check comprises determining the temporal distance 503 between the two successive UWB transmissions 413 and 431, then the temporal distance 505 between 432 and 414, and the temporal distance 507 between 415 and 433.

The check S20 then comprises checking that each of the determined temporal distances 503, 505 and 507 is at least greater than the predetermined temporal distance value. For example, the method can check successively that each of the determined temporal distances 503, 505 and 507 is at least greater than the predetermined temporal distance value. Alternatively, the method can check in parallel that each of the determined temporal distances 503, 505 and 507 is at least greater than the predetermined temporal distance value.

In this example, the method determines the temporal distances successively by following the time line, then checks that each of these temporal distances is at least greater than the predetermined temporal distance value. In other examples, the method can determine the set of temporal distances in another way, for example by determining the temporal distances separating all of the UWB transmissions from one another and by checking that all of these temporal distances are well above the predetermined temporal distance value.

In this second example, the check is successful. Each of the determined temporal distances 503, 505 and 507 is therefore at least greater than the predetermined temporal distance value. The method then comprises executing S20 the first localization 314 and the second localization 334 according to the initially received programming.

In this second implementation example also, the temporal distances between the UWB transmissions of the third localization 315 and the fourth localization 325 are all greater than the predetermined temporal distance value. Only the temporal distances between the UWB transmissions of the third localization 315 and the fifth localization 335 are not all greater than the predetermined temporal distance value. The check S20′ on the execution reliability of the programming of the third localization 315 and the fourth localization 325 is therefore successful, and the check S20′ on the execution reliability of the programming of the third localization 315 and the fifth localization 335 fails.

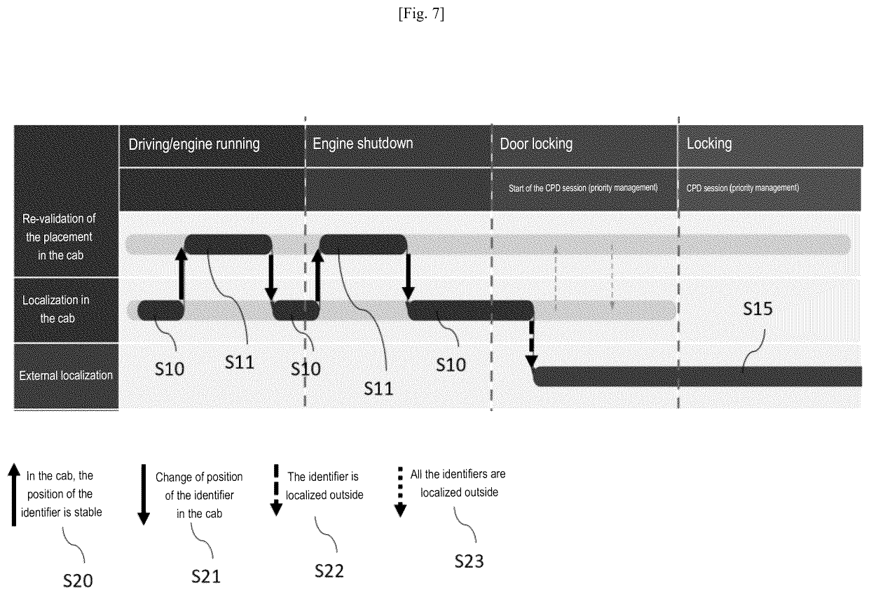

The method therefore comprises modifying the programming and, in this second example, this modification comprises cancelling S335 the fifth localization 335 initially programmed for the third UWB device 303 only. Modifying the programming does not comprise cancelling the fourth localization 325 since the third 315 and fourth 325 localizations can be executed together without risk of interference between the UWB transmissions.

[FIG. 7] shows an example of a use of the vehicle based on the localizations programmed according to the method.

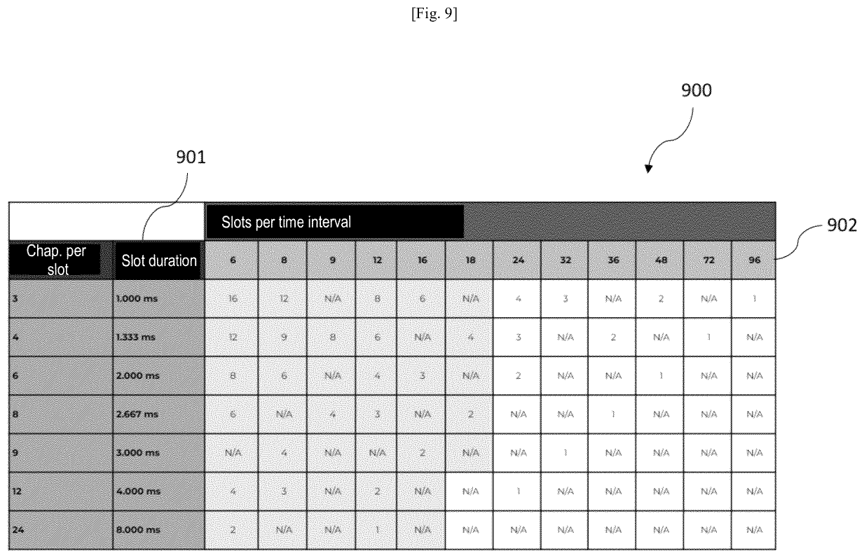

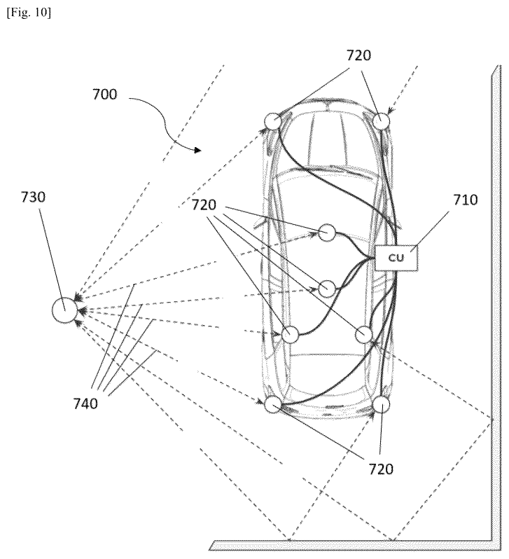

During the driving/running of the engine of the vehicle, the use comprises localizing S10 a UWB device carried by the driver (the “identifier”) in the cab. Following a detection of a stable position S20 of the identifier in the cab (for example following a plurality of localizations in the same position of the identifier), the use comprises re-evaluating S11 the placement of the identifier in the cab. The use then comprises changing S21 the position of the identifier in the cab and then re-localizing S10 the identifier in the cab. After the engine has stopped, the use once more comprises detecting a stable position S20 of the identifier in the cab, re-evaluating S11 the placement of the identifier in the cab, then changing S21 the position of the identifier in the cab and then re-localizing S10 the identifier in the cab. The use also comprises externally localizing S15 all of the identifiers after the identifier has been localized S22 outside. At the time of locking, the use can comprise one or more radar measurements to check for the absence of occupants who would have remained in the vehicle after locking.

[FIG. 8] shows an example of the localization of a UWB device with the one or more UWB sensors. The localization comprises two transmissions 410 of a frame over two first time slots from the UWB device 400 to each of the UWB sensors 401 (which is equivalent to 205 in FIGS. 3), 402, 403. The localization then comprises the transmitting, successively and in a respective time slot, of a frame by each of the UWB sensors (frame 412 for 401, frame 413 for 402 and frame 414 for 403). The localization then comprises two transmissions 415 of a frame over two last time slots from the UWB device 400 to each of the UWB sensors 401, 402, 403.

[FIG. 9] shows an example of the determination of the number of time slots of each series for a UWB device. The determination can be based on the application of a standard, for example using the table 900. The determination comprises determining a time slot duration 901 for the UWB device. For example, the UWB device can communicate its duration to the UWB system. The table 900 comprises a series of numbers 902, each adapted for the UWB system. The determination comprises determining a number of time slots per time interval based on the series 902. The number of time slots corresponds to the number of the predetermined series that is closest to and greater than or equal to the sum of the number of UWB sensors in the system and a constant (for example 4). The table 900 also comprises the number of time intervals per block as a function of the time slot duration and the number of time slots per series. For example, in this table 900, for a time slot duration of 1 millisecond and 12 time slots per series, the number of time intervals per block is 8. The determination can comprise determining a number of time intervals per block depending on the time slot duration and the number of time slots per time interval.

[FIG. 10] shows an example of a vehicle UWB system 700. The UWB system 700 comprises a central unit 710 and a plurality of UWB sensors 720 positioned at the front of the vehicle, at the rear of the vehicle or in the cab of the vehicle. The UWB system 700 also comprises connection means between each of the UWB sensors 720 and the central unit 710. The figure also shows a UWB device 730, which is registered on the UWB system 700. A localization comprises UWB exchanges 740 between the UWB device 730 and each of the UWB sensors 720.

1. A method for using a vehicle UWB system comprising one or more UWB sensors and having registered a set of UWB devices, the set of UWB devices comprising a first UWB device and a second UWB device, the method comprising:
for each UWB device, a periodic reception of a programming of localizations by the one or more UWB sensors, including a first localization and a second localization,
wherein the first localization is a localization of the first UWB device programmed over a first time interval, and the second localization is a localization of the second UWB device programmed over a second time interval,
wherein the first time interval and the second time interval having a non-zero intersection for at least one period; and
for each of the at least one period, periodically checking a reliability of execution of the programming of the first localization and the second localization and, if the check fails, modifying the programming.

2. The method according to claim 1, in which each localization comprises UWB transmissions, the check comprising:
determining a temporal distance between the UWB transmissions of the first localization and the UWB transmissions of the second localization, and
checking that each of the determined temporal distances is at least greater than a predetermined temporal distance value.

3. The method according to claim 1, in which modifying (S30) the programming if the check fails comprises:
determining a priority UWB device from the first UWB device and the second UWB device; and
programming the localization of the priority UWB device

4. The method according to claim 1, in which a predetermined temporal distance value is greater than 250 microseconds and/or less than 1 millisecond.

5. The method according to claim 1, in which the programming of the localizations is carried out for a time period of less than 10 seconds.

6. The method according to claim 1, in which the method comprises:
detecting a new UWB device; and
repeating the reception of the programming and the check for the new UWB device.

7. The method according to claim 1, the method comprising, after the check:
executing the localizations according to the received programming if a verification is successful, or according to the modified programming if the check fails; and
determining a position of each of the UWB devices from the executed localizations.

8. A vehicle UWB system comprising one or more UWB sensors and configured to be used according to the method as claimed in claim 1.

9. A UWB sensor for a vehicle UWB system configured for a use of the system according to the method as claimed in claim 1.

10. A non-transitory computer readable medium comprises a computer program comprising program code instructions for carrying out the method according to claim 1, when said program is executed by a processor.
